(19) United States
(12) Patent Application Publication
(10) Pub. No.: US 2007/0144640 A1
(43) Pub. Date: Jun. 28, 2007

(54) Tire with sacrificial strip for correcting dynamic imbalance

(76) Inventors: Robert Allen Losey, Kent, OH (US); Junling Zhao, Hudson, OH (US)

Correspondence Address: The Goodyear Tire & Rubber Company;Patent & Trademark Department - D/823, 1144 East Market Street, Akron, OH, 44316-0001, US

(21) Appl. No.: 11/546,167

(22) Filed: Oct. 11, 2006

Related U.S. Application Data
(60) Provisional application No. 60/754,408, filed on Dec. 28, 2005.

(51) Int. Cl. B60C 19/00

(52) U.S. Cl. 152/154.1; 156/75; 156/110.1

(57) ABSTRACT

A tire comprising a tread portion and a pair of sidewalls is provided wherein the sidewalls are connected to the tread portion by shoulder regions, wherein the tire further include one or more strips of rubber affixed to the inner surface of a green tire. The strip may be annular and may be located near the toe of the bead. The strip is made from a rubber composition having a specific gravity greater than 2. The strip may be ground away as desired in order to balance the tire without the need for weights.

This application claims the benefit of, and incorporates by reference, U.S. Provisional Application No. 60/754,408 filed Dec. 28, 2005.

### FIELD OF THE INVENTION

The invention relates to the dynamic balancing of tires.

### BACKGROUND OF THE INVENTION

It is difficult to produce tires with precision sufficient for the tire to be in dynamic balance. Wheel assemblies are typically balanced by adding balancing weights to the assembly prior to installation upon a vehicle. Another prior art method of correcting tire imbalance is by gluing weights or other objects inside the tire. This method has numerous problems associated with it such as the adhesive not setting up, or not adhering properly due to the bladder release agent on the rubber.

### BRIEF DESCRIPTION OF THE DRAWINGS

The invention will be described by way of example and with reference to the accompanying drawings in which:

FIG. 1 is a cross sectional view of the tire of the present invention;

FIG. 2 is a close-up view of the bead area of the tire of FIG. 1.

### DEFINITIONS

“Aspect Ratio” means the ratio of a tire's section height to its section width.

“Axial” and “axially” means the lines or directions that are parallel to the axis of rotation of the tire.

Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### DETAILED DESCRIPTION OF THE INVENTION

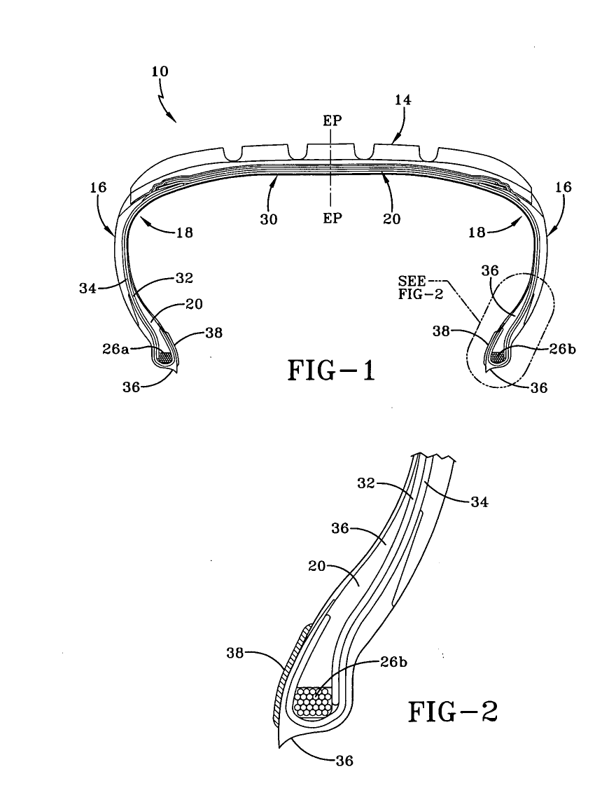

With particular reference to FIG. 1, there is illustrated a cross-sectional view of a first embodiment of a tire 10 of the present invention. The tire 10 has a tread portion 14 and a pair of sidewalls 16 wherein the sidewalls are connected to the tread portion by shoulder regions 18. The tire may have one or more reinforcing belts 20 which laterally extend under the tread 14. A carcass 10 of the tire includes an innerliner 30 which extends from bead 26a to bead 26b. The carcass further comprises a first ply layer 32 and a second ply layer 34. The carcass may comprise additional ply layers if needed. The tire may further comprise an optional apex 20 located in the bead area adjacent the ply turnup.

The tire 10 further includes one or more strips 38 of rubber affixed to the inner edge of the bead area of the tire. The strip is preferably annular. The strip may have a width in the range of about 0.25 to about 1 inch, or any desired width. The strip may be made of any rubber or elastomeric compound that has a density or specific gravity greater than 2, and more typically in the range of about 4 to about 8. The strip is heavier than normal rubber and acts like a weight near the toe of the tire. The strip is affixed to the tire prior to vulcanization and stays adhered to the tire after vulcanization. After the tire is manufactured, the strip may be grinded away in the areas needed to balance the tire. The strip may be grinded away after vulcanization. Thus there would be no need for additional tire weights due to a tire imbalance.

It is readily understood by those having skill in the art that the rubber compositions used in the strip 38 would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

The rubber compound may contain various conventional rubber additives. Typical additions of carbon black comprise about 20 to 200 parts by weight per 100 parts by weight of diene rubber (phr), preferably 50 to 100 phr.

A number of commercially available carbon blacks may be used. Included in the list of carbon blacks are those known under the ASTM designations N299, S315, N326, N330, M332, N339, N343, N347, N351, N358, N375, N539, N550 and N582. Processing aids may be present and can include, for example, aromatic, naphthenic, and/or paraffinic processing oils. Typical amounts of tackifying resins, such as phenolic tackifiers, range from 1 to 3 phr. Silica, if used, may be used in an amount of about 5 to about 80 phr, often with a silica coupling agent. Representative silicas may be, for example, hydrated amorphous silicas. Typical amounts of antioxidants comprise about 1 to about 5 phr. Representative antioxidants may be, for example, diphenyl-p-phenylenediamine, polymerized 1,2-dihydro-2,2,4-trimethylquinoline and others, such as, for example, those disclosed in the Vanderbilt Rubber Handbook (1990), Pages 343 through 362. Typical amounts of antiozonants comprise about 1 to about 5 phr. Representative antiozonants may be, for example, those disclosed in the Vanderbilt Rubber Handbook (1990), Pages 363 through 367. Typical amounts of fatty acids, if used, which can include stearic acid comprise about 0.5 to about 3 phr. Typical amounts of zinc oxide comprise about 2 to about 10 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Instead of carbon black, the composition may contain any heavy material powder such as tungsten, lead, copper, nickel, steel, zinc in an amount sufficient to achieve the desired specific gravity.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur vulcanizing agent is elemental sulfur. As known to those skilled in the art, sulfur vulcanizing agents are used in an amount ranging from about 0.5 to about 5 phr, or even, in some circumstances, up to about 8 phr, with a range of from about 3 to about 5 being preferred.

Accelerators are used to control the time and/or temperature required for vulcanization and to improve the properties of the vulcanizate. In one embodiment, a single accelerator system may be used, i.e., primary accelerator. Conventionally, a primary accelerator is used in amounts ranging from about 0.5 to about 2.5 phr. In another embodiment, combinations of two or more accelerators which is generally used in the larger amount (0.5 to 2.0 phr), and a secondary accelerator which is generally used in smaller amounts (0.05 to 0.50 phr) in order to activate and to improve the properties of the vulcanizate. Combinations of these accelerators have been known to produce a synergistic effect of the final properties and are somewhat better than those produced by use of either accelerator alone. In addition, delayed action accelerators may be used which are not affected by normal processing temperatures but produce satisfactory cures at ordinary vulcanization temperatures. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

### EXAMPLE 1

One example of a rubber composition suitable for use with the invention is as follows. The rubber composition is comprised of natural rubber in the amount of about 100 parts of natural rubber, microcrystalline wax of about 1 phr, wax of about 0.5 phr, processing oil of about 10 phr, zinc oxide of about 5 phr, stearic acid of about 2 phr, and tungsten powder of about 1100 phr. The composition further comprises sulfer in the amount of about 2.5 phr, sulfedamide accelerator of about 1.2 phr and bismalium accelerator in the range of about 1 phr. The above composition has a specific gravity of about 6.5, resulting in a very heavy rubber compound.

The tire can be built, shaped, molded and cured by various methods which will be readily apparent to those having skill in such art. As noted previously herein, strip 38 is covulcanized with the tire in order to be integral with the dynamic tire construction. It is built as a solid unvulcanized layer onto the inner portion of the green, unvulcanized tire and then shaped, molded and heated under pressure to simultaneously covulcanize therewith.

In a variation of the above described embodiments, the strip or balance patch may be applied to a post cure tire (as opposed to a green tire) near the bead area as described above. The strips or balance patches are made as described above, except that they are cured and then applied to a post cure tire. The strip or balance patch may be glued to the inside of the tire. As described above, the strip or balance patch may be ground away in order to balance the tire. The strip or balance patch may be adhered to the tire using velcro or interlocking (hook and loop) fastener means. The strip or balance patch may have a first fastener means cured or glued thereto. The tire may have a second interlocking strip cured or glued thereto for fastening with the strip or balance patch.

Alternatively, a velcro strip may be cured, glued or otherwise affixed to the inside of the tire. Weights with the velcro strips affixed can be added where it is needed and the location can be easily changed if needed.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire comprising a tread portion and a pair of sidewalls wherein the sidewalls are connected to the tread portion by shoulder regions, one or more reinforcing belts which laterally extend under the tread, and a carcass which includes one or more layers of ply which extend from a first bead to a second bead, and further including one or more strips of rubber affixed to the inner surface of the tire.

2. The tire of claim 1 wherein the strip is annular.

3. The tire of claim 1 wherein the strip is located near the toe of the bead.

4. The tire of claim 1 wherein the strip has a specific gravity greater than 2.

5. A method of correcting dynamic tire imbalance comprising: making a green tire, applying one or more strips having a specific gravity greater than 4 to the green tire, vulcanizing the tire in a mold.

6. The method of claim 5 wherein the strip is annular.

7. The method of claim 5 wherein the tire is dynamically tested for imbalance, and then the strip is ground away in one or more areas needed to balance the tire.
